(19) United States
(12) Patent Application Publication
(10) Pub. No.: US 2022/0188723 A1
(43) Pub. Date: Jun. 16, 2022

(54) SYSTEMS AND METHODS FOR PROCESSING A TRANSPORTATION SERVICE REQUEST

(71) Applicant: BEIJING DIDI INFINITY TECHNOLOGY AND DEVELOPMENT CO., LTD., Beijing (CN)

(72) Inventors: Conghui Fu, Sunnyvale, CA (US); Wei Wang, Sunnyvale, CA (US); Zetian Ni, Sunnyvale, CA (US); Zihan Yi, Mountain View, CA (US); Kaidan Yang, Beijing (CN); Zhendong Li, Burlingame, CA (US); Yifang Yuan, Beijing (CN); Xin Chen, Sunnyvale, CA (US)

(73) Assignee: BEIJING DIDI INFINITY TECHNOLOGY AND DEVELOPMENT CO., LTD., Beijing (CN)

(21) Appl. No.: 17/123,103

(22) Filed: Dec. 15, 2020

(51) Int. Cl. G06Q 10/06; G06N 20/00

(52) U.S. Cl. CPC G06Q 10/06311; G06N 20/00

(57) ABSTRACT

Embodiments of the disclosure provide systems and methods for processing a transportation service request. An exemplary system may include a communication interface configured to receive the transportation service request from a terminal device. The system may further include at least one processor. The at least one processor may be configured to generate a passenger score based on the received transportation service request using a first machine learning model trained with sample passenger data associated with past impacted drivers. The at least one processor may further be configured to generate a trip score based on the generated passenger score and the received transportation service request using a second machine learning model trained with sample trip data associated with the past impacted drivers. The at least one processor may also be configured to allow or block the received transportation service request based on the generated trip score.

### TECHNICAL FIELD

The present disclosure relates to systems and methods for processing a transportation service request, and more particularly to, estimating a trip risk associated with a transportation service request using one or more machine learning models.

### BACKGROUND

An online ride-hailing platform (e.g., DiDi™ online) can receive a rideshare service request from a passenger and then route the service request to at least one transportation service provider (e.g., a taxi driver, a private car owner, or the like). After the transportation service request is answered by the driver, the driver will pick up the passenger, and drive the passenger to the requested destination.

The driver and the passenger otherwise do not know each other prior to the rideshare service. Sometimes, a person may disguise himself as the passenger to request a transportation service in order to commit crimes against the driver, such as robbery, assault, battery, or sexual harassment. For example, the disguised passenger may rob the driver either during the trip or at the destination. Sometimes, a passenger may commit a crime spontaneously triggered by circumstances during the trip, such as a conflict between the driver and the passenger. For example, the passenger may disagree about the route the driver takes for the trip or the fees charged for the service, the passenger then may attack and force the driver to change the route or reduce the fees charged for the service.

A rideshare vehicles may equip with an in-vehicle crime detection system for real-time detecting the above-mentioned crimes in the rideshare service. For example, if an in-vehicle crime is detected, the crime detection system may automatically notify the ride-hailing platform to call a nearby police to report the crime. However, crime detection system could only serve to mitigate the harm after the fact, but could not prevent the crime from happening. For example, existing ride-hailing platforms with in-vehicle crime detection systems may not allow or block the service request based on an estimated trip risk.

Embodiments of the disclosure provide systems and methods for estimating a trip risk associated with a transportation service request using machine learning models and processing the transportation service request based on the trip risk.

### SUMMARY

Embodiments of the disclosure provide a system for processing a transportation service request. An exemplary system may include a communication interface configured to receive the transportation service request from a terminal device. The system may further include at least one processor. The at least one processor may be configured to generate a passenger score based on the received transportation service request using a first machine learning model trained with sample passenger data associated with past impacted drivers. The at least one processor may further be configured to generate a trip score based on the generated passenger score and the received transportation service request using a second machine learning model trained with sample trip data associated with the past impacted drivers. The at least one processor may also be configured to allow or block the received transportation service request based on the generated trip score.

Embodiments of the disclosure also provide a method for processing a transportation service request. An exemplary method may include receiving the transportation service request, by a communication interface, from a terminal device. The method may further include generating, by at least one processor, a passenger score based on the received transportation service request using a first machine learning model trained with sample passenger data associated with past impacted drivers. The method may also include generating, by the at least one processor, a trip score based on the generated passenger score and the received transportation service request using a second machine learning model trained with sample trip data associated with the past impacted drivers. The method may additionally include allowing or blocking the received transportation service request, by the at least one processor, based on the generated trip score.

Embodiments of the disclosure further provide a non-transitory computer-readable medium having instructions stored thereon that, when executed by at least one processor, causes the at least one processor to perform a method for processing a transportation service request. An exemplary method may include receiving the transportation service request from a terminal device. The method may further include generating a passenger score based on the received transportation service request using a first machine learning model trained with sample passenger data associated with past impacted drivers. The method may also include generating a trip score based on the generated passenger score and the received transportation service request using a second machine learning model trained with sample trip data associated with the past impacted drivers. The method may additionally include allowing or blocking the received transportation service request based on the generated trip score.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates an exemplary transportation service request processing system, according to embodiments of the disclosure.

FIG. 2 illustrates a block diagram of an exemplary request processing device, according to embodiments of the disclosure.

FIG. 3 illustrates a data flow diagram of an exemplary model training device illustrated in FIG. 1, according to embodiments of the disclosure.

FIG. 4 illustrates another data flow diagram of an exemplary model training device illustrated in FIG. 1, according to embodiments of the disclosure.

FIG. 5 is a flowchart of an exemplary method for processing a transportation service request based on a trip risk, according to embodiments of the disclosure.

FIG. 6 is a flowchart of an exemplary method for generating a passenger score, according to embodiments of the disclosure.

FIG. 7 is a flowchart of an exemplary method for generating a trip score, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

The disclosed systems and methods automatically estimating a trip risk associated with a transportation service request using machine learning models and processing the transportation service request based on the trip risk. In some embodiments, the machine learning models include passenger score models, trip score models, and a rule-based model. The passenger score models are trained with passenger data associated with impacted drivers being victims of at least one of reported safety events. The trip score models are trained with trip data associated with impacted drivers and passenger scores generated using the passenger score models. In some embodiments, the different passenger score models and trip score models are trained for different groups of passengers. The rule-based model is trained with the passenger data and the trip data associated with impacted drivers. In some embodiments, when the ride-hailing platform receives a transportation service request, a passenger score model is selected among the ones trained based on the group the passenger requesting the transportation service belongs. The selected passenger score model may be applied on passenger information of the received transportation service request to generate a passenger score. Accordingly, a trip model trained for the passenger group is selected. The selected trip model may be applied on trip information of the received transportation service request and the generated passenger score to generate a trip score.

In some embodiments, if the generated trip score is above a predetermined score threshold, a whitelist (e.g., a list of safe passengers and a list of safe scenarios) may be compared with the passenger information and the trip information of the transportation service request. If the passenger information or the trip information matches any key in the whitelist, the transportation service request will be allowed to route to the service providers. Otherwise, the transportation service request will be blocked. If the generated trip score is equal to or below the predetermined score threshold, the rule-based model may be applied on the passenger information and the trip information of the transportation service request. If the rule-based model identifies the passenger or the request scenario as unsafe, the transportation service request will be blocked. Otherwise, the transportation service request will be allowed to route to the service providers.

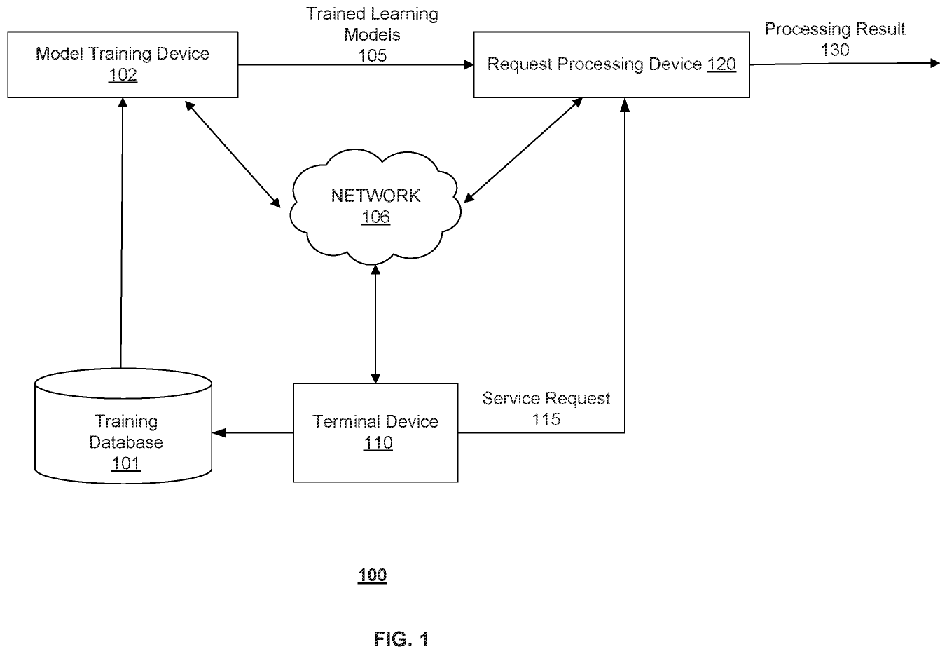

FIG. 1 illustrates an exemplary transportation service request processing system 100 (referred to as “system 100” hereafter), according to embodiments of the disclosure. In some embodiments, system 100 may be configured to estimate a trip risk associated with a transportation service request from a terminal device and process the transportation request based on the trip risk. As shown in FIG. 1, system 100 may include components for performing two phases, a training phase and a request processing phase. To perform the training phase, system 100 may include a training database 101 and a model training device 102. To perform the request processing phase, system 100 may include a request processing device 120. In some embodiments, system 100 may include more or less of the components shown in FIG. 1. For example, when machine learning models for estimating the trip risk is pre-trained and provided, system 100 may include only request processing device 120.

In some embodiments, system 100 may optionally include a network 106 to facilitate the communication among the various components of system 100, such as training database 101, model training device 102, request processing device 120, and a terminal device 110. For example, network 106 may be a local area network (LAN), a wireless network, a cloud computing environment (e.g., software as a service, platform as a service, infrastructure as a service), a client-server, a wide area network (WAN), etc. In some embodiments, network 106 may be replaced by wired data communication systems or devices.

In some embodiments, the various components of system 100 may be remote from each other or in different locations, and be connected through network 106 as shown in FIG. 1. In some alternative embodiments, certain components of system 100 may be located on the same site or inside one device. For example, training database 101 may be located on-site with or be part of model training device 102. As another example, model training device 102 and request processing device 120 may be inside the same computer or processing device.

As shown in FIG. 1, model training device 102 may communicate with training database 101 to receive one or more sets of training data. Model training device 102 may use the training data received from training database 101 to train a plurality of machine learning models (e.g., trained learning models 105). Trained learning models 105 may include passenger score models, trip score models, a rule-based model, and the like. For example, the passenger score models may be trained as tree-based classification models based on passenger training data. The trip score models may be trained as different tree-based classification models based on trip training data and passenger scores generated using the passenger score models. The rule-based model may be trained based on the passenger training data and/or trip training data. The rule-based model may be configured to identify whether the service request is associated with unsafe passengers or unsafe scenarios.

Most trips can be safely completed without reported crimes. For example, only 50 out of 100,000 completed trips may have crimes reported. Therefore, using all the trip data for training the machine learning models may cause training imbalance. In some embodiments, model training device 102 may filter the sample data (e.g., passengers and completed trips) before training machine learning models. In some embodiments, model training device 102 may select passenger data and trip data associated with impacted drivers for training the machine learning models. For example, the impacted drivers may be drivers who have experienced at least one crime such as a robbery. Data associated with transportation service requests made by passengers who have been served by the impacted drivers are then selected as passenger training data. In some embodiments, the training data is labeled based on whether a crime is committed to the impacted driver. For example, a passenger who has committed a crime to the impacted driver is labeled as a positive sample (e.g., unsafe passenger); otherwise, the passenger is labeled as a negative sample (e.g., safe passenger). Similarly, trips that the impacted drivers have completed are labeled as safe trips and unsafe trips. For example, a safe trip is not associated with any reported crimes. An unsafe trip is associated with at least one of the reported crimes.

In some embodiments, the training phase may be performed “online” or “offline.” An “online” training refers to performing the training phase contemporarily with the request processing phase, e.g., learning the models in real-time just prior to estimating the trip risk based on the service request. An “online” training may have the benefit to obtain a most updated machine learning models based on the training data that is then available. However, an “online” training may be computational costive to perform and may not always be possible if the training data is large and/or the models are complicate. Consistent with the present disclosure, an “offline” training is used where the training phase is performed separately from the request processing phase. The learned models trained offline are saved and reused for estimating the trip risk.

Model training device 102 may be implemented with hardware specially programmed by software that performs the training process. For example, model training device 102 may include a processor and a non-transitory computer-readable medium. The processor may conduct the training by performing instructions of a training process stored in the computer-readable medium. Model training device 102 may additionally include input and output interfaces to communicate with training database 101, network 106, and/or a user interface (not shown). The user interface may be used for selecting sets of training data, adjusting one or more parameters of the training process, selecting or modifying a framework of the machine learning models, and/or manually or semi-automatically providing ground-truth associated with the training data.

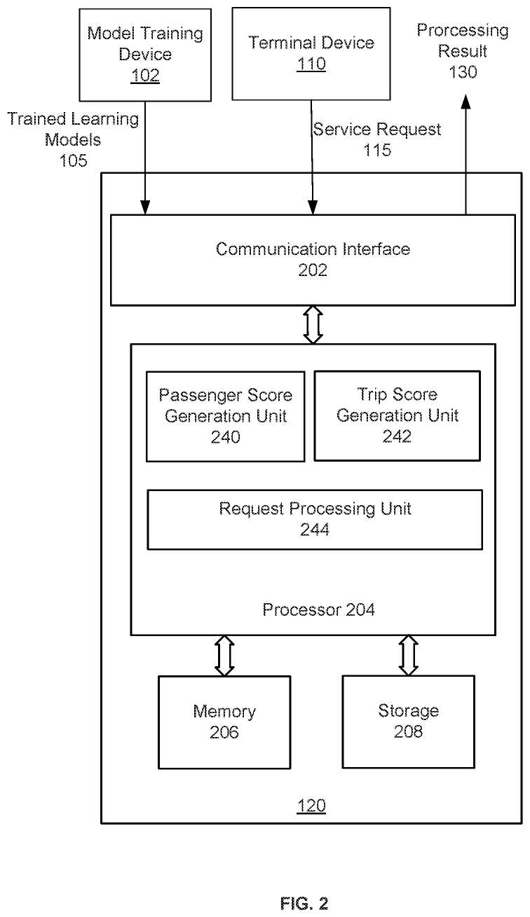

Trained learning models 105 may be used by request processing device 120 to estimate the trip risk based on the service request that is not associated with a ground-truth. Request processing device 120 may receive trained learning models 105 from model training device 102. Request processing device 120 may include a processor and a non-transitory computer-readable medium (discussed in detail in connection with FIG. 2). The processor may perform instructions of a sequence of processes stored in the medium for estimating the trip risk and processing the service request. Request processing device 120 may additionally include input and output interfaces to communicate with terminal device 110, network 106, and/or a user interface (not shown). The user interface may be used for receiving one or more service requests for trip risk estimation, initiating the estimation process, displaying a processing result (e.g., processing result 130). For example, processing result 130 may include a generated passenger score, a generated trip score, and a decision whether to allow or block the service request.

Request processing device 120 may communicate with terminal device 110 to receive one or more service requests 115. In some embodiments, terminal device 110 may be a mobile phone, a wearable device, a PDA, etc. used by the user (e.g., the passenger) to make a transportation service request (e.g., service request 115). In some embodiments, service request 115 may include passenger information and trip information. For example, the passenger information may include passenger demographic information (e.g., passenger name, gender, register time, contact, address, and the like). The trip information may include a pickup time and location, and a destination for the trip. Request processing device 120 may use trained learning models 105 received from model training device 102 to perform one or more of: (1) generating a passenger score based on the received transportation service request, (2) generating a trip score based on the received transportation service request and the generated passenger score, and (3) allowing or blocking the received service request based on the generated trip score.

For example, FIG. 2 illustrates a block diagram of an exemplary request processing device 120, according to embodiments of the disclosure. Consistent with the present disclosure, request processing device 120 may receive service request 115 from terminal device 110 and trained learning models 105 from model training device 102. Request processing device 120 may process service request 115 to generate the passenger score and the trip score. Request processing device 120 may further process the service request based on the trip score and send processing result 130 to the ride-hailing platform. In some embodiments, processing result 130 may include a decision to allow or block the service request.

In some embodiments, as shown in FIG. 2, request processing device 120 may include a communication interface 202, a processor 204, a memory 206, and a storage 208. In some embodiments, request processing device 120 may include different modules in a single device, such as an integrated circuit (IC) chip (implemented as an application-specific integrated circuit (ASIC) or a field-programmable gate array (FPGA)), or separate devices with dedicated functions. In some embodiments, one or more components of request processing device 120 may be located in a cloud, or may be alternatively in a single location (such as a mobile device) or distributed locations. Components of request processing device 120 may be in an integrated device, or distributed at different locations but communicate with each other through a network (not shown).

Communication interface 202 may send data to and receive data from components such as terminal device 110 via communication cables, a Wireless Local Area Network (WLAN), a Wide Area Network (WAN), wireless networks such as radio waves, a cellular network, and/or a local or short-range wireless network (e.g., Bluetooth™), or other communication methods. In some embodiments, communication interface 202 can be an integrated services digital network (ISDN) card, cable modem, satellite modem, or a modem to provide a data communication connection. As another example, communication interface 202 can be a local area network (LAN) card to provide a data communication connection to a compatible LAN. Wireless links can also be implemented by communication interface 202. In such an implementation, communication interface 202 can send and receive electrical, electromagnetic or optical signals that carry digital data streams representing various types of information via a network.

Consistent with some embodiments, communication interface 202 may receive service request 115 from terminal device 110. Communication interface 202 may further provide the received data to storage 208 for storage or to processor 204 for processing.

Processor 204 may be a processing device that includes one or more general processing devices, such as a microprocessor, a central processing unit (CPU), a graphics processing unit (GPU), and the like. More specifically, processor 204 may be a complex instruction set computing (CISC) microprocessor, a reduced instruction set computing (RISC) microprocessor, a very long instruction word (VLIW) microprocessor, a processor running other instruction sets, or a processor that runs a combination of instruction sets. Processor 204 may also be one or more dedicated processing devices such as application specific integrated circuits (ASICs), field programmable gate arrays (FPGAs), digital signal processors (DSPs), system-on-chip (SoCs), and the like.

Processor 204 may be configured as a separate processor module dedicated to performing processing service request 115 received from terminal device 110. Alternatively, processor 204 may be configured as a shared processor module for performing other functions. Processor 204 may be communicatively coupled to memory 206 and/or storage 208 and configured to execute the computer-executable instructions stored thereon.

Memory 206 and storage 208 may include any appropriate type of mass storage provided to store any type of information that processor 204 may need to operate. Memory 206 and storage 208 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Memory 206 and/or storage 208 may be configured to store one or more computer programs that may be executed by processor 204 to perform service request processing and trip risk estimation disclosed herein. For example, memory 206 and/or storage 208 may be configured to store program(s) that may be executed by processor 204 to generate the passenger score, generate the trip score, and determine allowing or blocking the received service request.

Memory 206 and/or storage 208 may be further configured to store information and data used by processor 204. For instance, memory 206 and/or storage 208 may be configured to store the various types of data such as data related to service requests received from terminal device 110 and data related to estimating the trip risk (e.g., passenger historical behaviors, passenger's travel patterns, and passenger's relationship graph). Memory 206 and/or storage 208 may also store intermediate data such as the generated passenger score and trip score based on service request 115. Memory 206 and/or storage 208 may further store the various machine learning models used by processor 204, such as the passenger score models, the trip score models, the rule-based model, and the like. The various types of data may be stored permanently, removed periodically, or disregarded immediately after each frame of data is processed.

As shown in FIG. 2, processor 204 includes multiple modules, such as a passenger score generation unit 240, a trip score generation unit 242, a request processing unit 244, and the like. These modules (and any corresponding sub-modules or sub-units) can be hardware units (e.g., portions of an integrated circuit) of processor 204 designed for use with other components or software units implemented by processor 204 through executing at least part of a program. The program may be stored on a computer-readable medium, and when executed by processor 204, it may perform one or more functions. Although FIG. 2 shows units 240-244 all within one processor 204, it is contemplated that these units may be distributed among multiple processors located near or remotely with each other.

In some embodiments, units 240-244 of FIG. 2 may execute computer instructions to perform trip risk estimation and request processing. In some embodiments, passenger score generation unit 240 is configured to generate the passenger score based on the received service request using a selected passenger score model. For example, based on a quantity of completed trips by the passenger, passenger score generation unit 240 may label the passenger as a new passenger, an infrequent passenger, or a frequent passenger. A new passenger may be a person new to making request through the ride-hailing platform and has not complete any trip yet with the ride-hailing platform. An infrequent passenger may be a person who has completed a few trips with the ride-hailing platform, but the number of the trips is less than a predetermined number threshold. When the number of the completed trips by the passenger exceeds the predetermined number threshold, the passenger may then become a frequent passenger. In some embodiments, passenger score generation unit 240 may select the passenger score model among several models trained for the different groups of passengers (e.g., new, infrequent, and frequent passengers) respectively. Passenger score generation unit 240 further apply the selected passenger score model on the received service request.

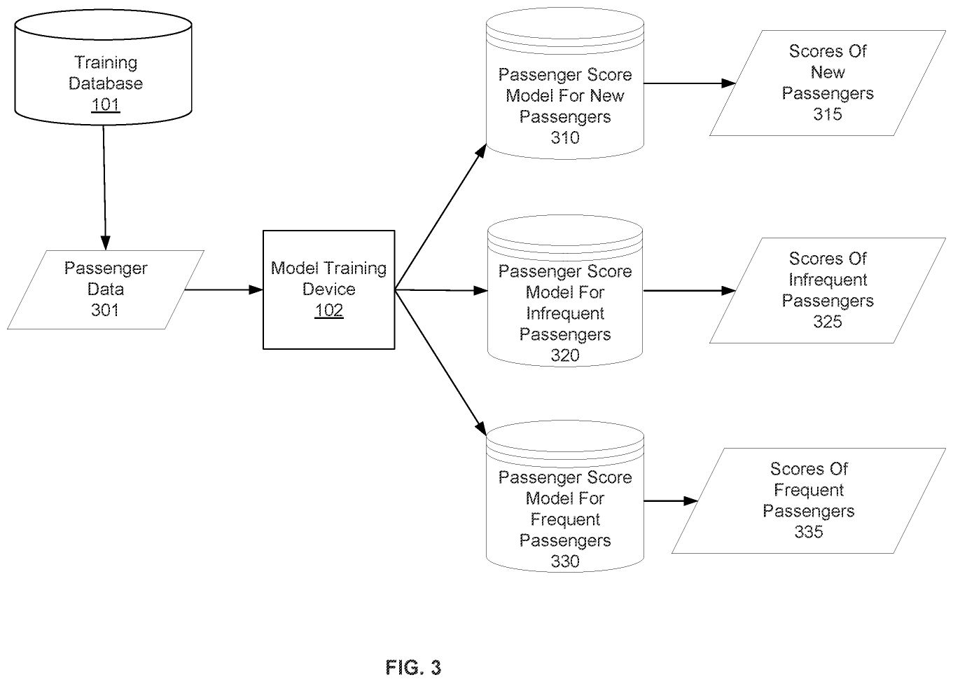

FIG. 3 illustrates a data flow diagram of an exemplary model training device 102 illustrated in FIG. 1, according to embodiments of the disclosure. As shown in FIG. 3, model training device 102 receives passenger data 301 from training database 101. Consistent with the present disclosure, passenger data 301 may include information of the passengers who have been served by the impacted drivers. For example, the passenger information may include the passenger demographics information, the passenger's cancelation rates, the passenger's night order rates, the passenger's destination changing rates, the passenger's travel patterns, the passenger's relationship graph, and the like. In some embodiments, the passenger demographics information may include passenger name, gender, register time, contact methods, address, etc.

In some embodiments, the passenger's cancelation rates may be calculated to measure how often service orders are canceled after they are placed during a certain time window. For example, the time window may be one day, three days, one month, three months, and the like. In some embodiments, a time window close to the pickup time (e.g., within three hours prior to the pickup time) is used for calculating the cancelation rates. In some embodiments, a cancelation rate may be defined as a ratio between the quantity of canceled orders and (a quantity of completed trips+1) in the corresponding time window.

In some embodiments, a frequent cancelation tag of the passenger may be used as a model input feature. For example, if the passenger canceled more than two transportation service orders within two hours prior to the service request, a value of the frequent cancelation tag of the passenger is set to true. A high cancelation rate usually associates with a high risk of crime. For example, the criminal may cancel an order if he sees that the answered driver is a strong male. The criminal may keep requesting and canceling service requests till a request he finds a driver as a suitable target.

In some embodiments, the passenger may frequently change the destination during the transportation. A high destination changing rate can also associate with a high risk of crime, because it reflects that the criminal is looking for a better place to commit a crime. The passenger's destination changing rates may also be calculated similarly to the calculation of the passenger's cancelation rate described above. The calculation may again use different time windows such as one day, three days, one month, three months, and the like.

In some embodiments, the passenger's travel patterns may include travel dates, travel times, destinations, etc. For example, a safe passenger may use the service to go to same destinations at similar times (e.g., on each Tuesday and Thursday at 9 AM and 5 PM). That is, the trips conducted by a safe passenger usually establishes a regular travel pattern. In some embodiments, the passenger's relationship graph may include information of whether a contact method (e.g., phone number) is associated with multiple passenger accounts and whether a known criminal is linked to the passenger through the relationship graph.

In some embodiments, passenger data 301 may include three passenger datasets: a new passenger dataset, an infrequent passenger dataset, and a frequent passenger dataset. The datasets are generated based on the quantity of the trips completed by the passengers in a predetermined time window (e.g., latest 12 months). Consistent with the present disclosure, passengers whose data are included in the new passenger dataset have not completed any trips. Passengers whose data are included in the infrequent passenger dataset have completed no more than the predetermined number threshold trips. Passengers whose data are included in the frequent passenger dataset have completed more than the predetermined threshold number of trips.

As shown in FIG. 3, model training device 102 may train a passenger score model 310 for new passengers (refers to as “model 310” hereafter) using the new passenger dataset as training data. Model training device 102 may further train a passenger score model 320 for infrequent passengers (refers to as “model 320” hereafter) using the infrequent passenger dataset as training data. Model training device 102 may also train a passenger score model 330 for frequent passengers (refers to as “model 330” hereafter) using the frequent passenger dataset as training data.

In some embodiments, model training device 102 may use one or more tree-based methods (e.g., random forests, XGBoost, LightGBM) to train models 310, 320, and 330, respectively. As a result, models 310, 320, and 330 may be tree-based classification models. In some embodiments, though only data associated with the passengers served by the impacted drivers are included in the training datasets, the training data may still be imbalanced. For example, a ratio of positive training samples (e.g., unsafe passengers) to negative training samples (e.g., safe passengers) may still be very small, such as less than 1/250. To solve the imbalanced training data issue, model training device 102 may further apply a positive scale weight on the imbalanced training data. Additionally, the imbalanced training data may result in an overfitted model. In some embodiments, model training device 102 may employ L1/L2 regularization methods to solve the overfitting issue. In some embodiments, model training device 102 may also use data transformation techniques (e.g., square root, log, 1/x) to reduce the skewness of the generated passenger scores.

As shown in FIG. 3, the trained models 310-330 may be later used by model training device 102 to generate passenger scores for the different groups of passengers, to be used as training data for training the trip score models. For example, model training device 102 may further use model 310 to generate scores 315 for new passengers based on the new passenger dataset. Model training device 102 may also use model 320 to generate scores 325 for infrequent passengers based on the infrequent passenger dataset, and use model 330 to generate scores 335 for frequent passengers based on the frequent passenger dataset. In some embodiments, scores 315, 325, and 335 may further be used for training the trip score models by model training device 102.

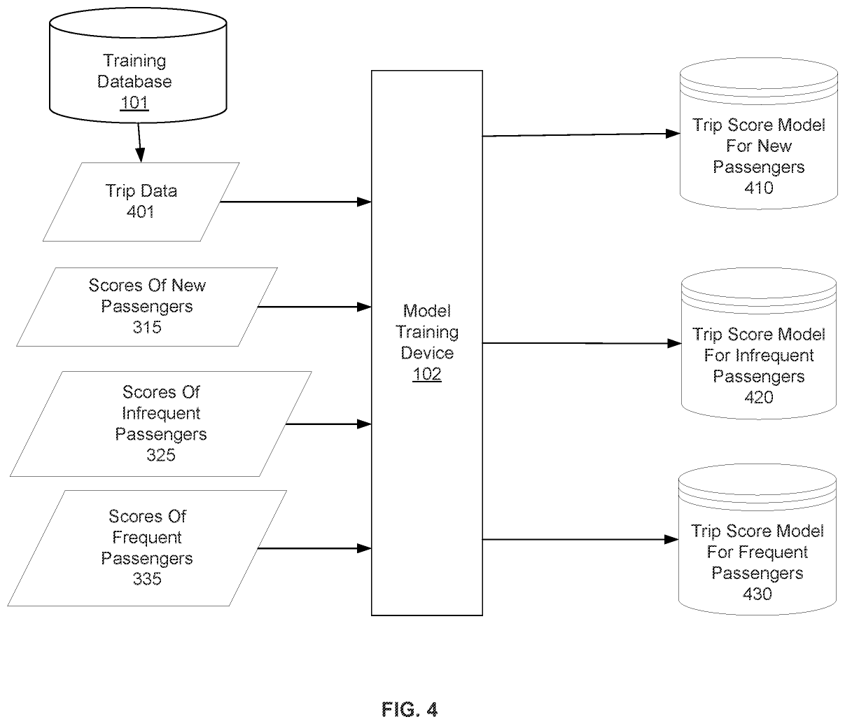

FIG. 4 illustrates another data flow diagram of an exemplary model training device 102 illustrated in FIG. 1, according to embodiments of the disclosure. As shown in FIG. 4, model training device 102 receives trip data 401 from training database 101. Consistent with the present disclosure, trip data 401 may include information of the trips answered (either complete or incomplete) by the impacted drivers. For example, the trip information may include the passenger pickup location, the destination, the trip date, start time and end time of the trip, and a remoteness score for the trip destination. In some embodiments, the remoteness score may be a value between 0 and 1. For example, if the trip destination is far away from an urban area or in a poor area, the remoteness score for the trip destination may be close to 1. In contrast, if the trip destination is near the urban area or a well-developed area, the remoteness score for the trip destination may be close to 0. A high remoteness score usually associates with a high risk of crime.

Consistent with some embodiments, model training device 102 may further receive scores 315, 325, and 335 for training the trip models. In some embodiments, model training device 102 may use one or more tree-based methods (e.g., random forests, XGBoost, LightGBM) based on trip data 401 and scores 315, 325, and 335 to train a trip score model 410 for new passengers (refers to as “model 410” hereafter), a trip score model 420 for infrequent passengers (refers to as “model 420” hereafter), and a trip score model 430 for frequent passengers (refers to as “model 430” hereafter), respectively. In some embodiments, trip data 401 may be imbalanced because most of trip data 401 are associated with safe trips (e.g., negative samples). To solve the imbalanced data issue, model training device 102 may apply another positive scale weight on trip data 401. In some embodiments, model training device 102 may further employ L1/L2 regularization methods to solve the overfitting issue due to the imbalanced data in trip data 401. In some embodiments, model training device 102 may also use data transformation techniques (e.g., square root, log, 1/x) to reduce the skewness of the generated trip scores.

In some embodiments, model training device 102 may jointly train a passenger score model (e.g., for new passengers) and a trip score model (e.g., for new passengers), using passenger data 301 and trip data 401. That is, the set of parameters of the two models are trained together, e.g., using a joint loss function. In some embodiments, the joint loss function may be a weighted combination of a passenger score loss and a trip score loss. For example, the passenger score loss may be a difference between a ground truth passenger score and a predicted passenger score. The trip score loss may be a difference between a ground truth trip score and a predicted trip score. In some embodiments, L1 loss may be used to represent the passenger score loss and the trip score loss. It is contemplated that other forms of differences, such as L2 loss, may be used to construct the loss function. The parameters of the two models may be initially set to certain values. The initial values may be predetermined, selected by an operator, or decided by model training device 102 based on prior data of similar passengers and trips.

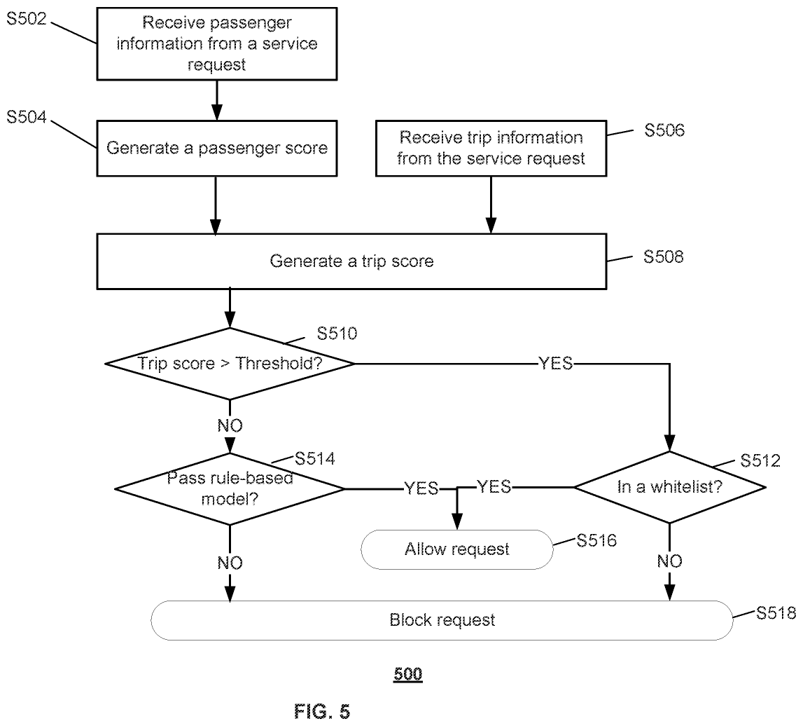

FIG. 5 is a flowchart of an exemplary method 500 for processing a transportation service request based on a trip risk, according to embodiments of the disclosure. Method 500 may be performed by request processing device 120 and particularly processor 204 or a separate processor not shown in FIG. 2. However, method 500 is not limited to that exemplary embodiment. Method 500 may include steps S502-S518 as described below. It is to be appreciated that some of the steps may be optional to perform the disclosure provided herein. Further, some of the steps may be performed simultaneously, or in a different order than shown in FIG. 5.

In step S502, request processing device 120 may be configured to communicate with terminal device 110 to receive service request 115. Consistent with some embodiments, service request 115 may include trip information (e.g., pickup time and location) and passenger information (e.g., name, gender, and contact methods). If any passenger or trip data of service request 115 is missing or unknown, request processing device 120 may fill the information based on values of the training data in the corresponding passenger group. For example, if the value of the passenger's gender is missing in service request 115 and the passenger has not completed any trips, request processing device 120 may fill the gender information for the passenger with the gender of the majority in the new passenger training dataset. In some embodiments, passenger score generation unit 240 of request processing device 120 may receive the passenger information of service request 115.

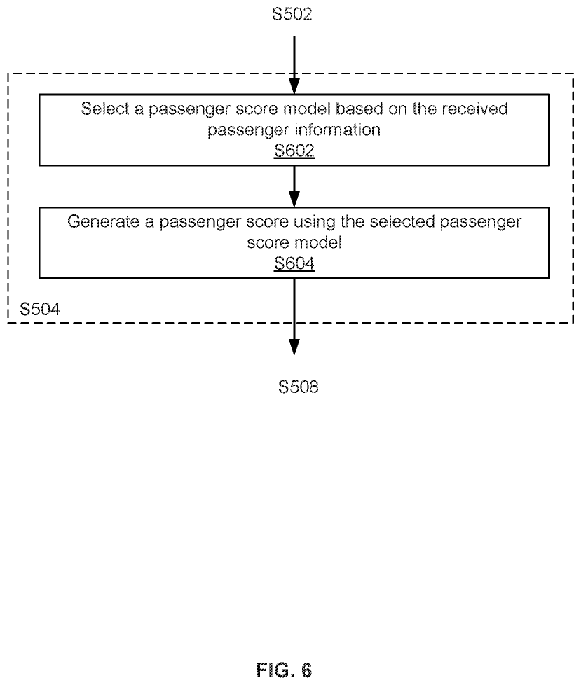

In step S504, passenger score generation unit 240 of request processing device 120 may be configured to generate a passenger score based on the received passenger information of service request 115. For example, FIG. 6 is a flowchart of an exemplary method for generating a passenger score, according to embodiments of the disclosure. In step S602, passenger score generation unit 240 may select a model from models 310, 320, and 330 to generate the passenger score based on the passenger group the passenger belongs to. In some embodiments, the passenger can be classified in a particular passenger group based on quantity of trips completed by the passenger in a predetermined time window associated with service request 115. For example, if the passenger has not completed any trips yet, passenger score generation unit 240 may apply model 310 on the passenger data to generate the passenger score. If the passenger is an infrequent passenger (e.g., completed less a threshold number of trips), passenger score generation unit 240 may apply model 320 on the passenger data to generate the passenger score. If the passenger is a frequent passenger, passenger score generation unit 240 may apply model 330 on the passenger data to generate the passenger score.

In some embodiments, passenger score generation unit 240 may further be configured to communicate with memory 206 and/or storage 208 to receive more passenger related information that may not be included in service request 115. For example, passenger score generation unit 240 may receive passenger travel behaviors and patterns data from memory 206 and/or storage 208 (e.g., passenger frequent cancelation tag, passenger's cancelation rates, passenger's night order rates, passenger's relationship graph). In some alternative embodiments, passenger travel behaviors and patterns data are not stored in memory 206 and/or storage 208, passenger score generation unit 240 may generate the passenger travel behaviors and patterns based on other data stored in memory 206 and/or storage 208. In step S604, passenger score generation unit 240 may be configured to apply the selected passenger score model on the passenger data to generate the passenger score.

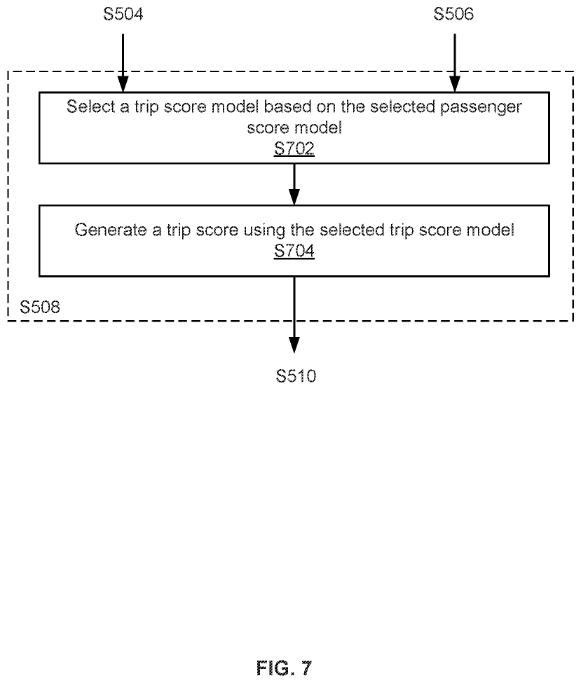

Returning to FIG. 5, in step S506, trip score generation unit 242 of request processing device 120 may receive trip information of service request 115. In step S508, trip score generation unit 242 may be configured to generate a trip score based on the received trip information from step S506 and the generated passenger score from step S504. For example, FIG. 7 is a flowchart of an exemplary method for generating a trip score, according to embodiments of the disclosure. In step S702, trip score generation unit 242 of request processing device 120 may be configured to select a trip score model from models 410, 420, and 430 based on the selected passenger score model in step S602. For example, if in step S602, passenger score generation unit 240 selects model 310 (e.g., for new passengers), trip score generation unit 242 may select model 410 (e.g., for new passengers) to generate the corresponding trip score. If in step S602, passenger score generation unit 240 selects model 320 (e.g., for infrequent passengers), trip score generation unit 242 may select model 420 (e.g., for infrequent passengers) to generate the corresponding trip score. If in step S602, passenger score generation unit 240 selects model 330 (e.g., for frequent passengers), trip score generation unit 242 may select model 430 (e.g., for frequent passengers) to generate the corresponding trip score. In some embodiments, trip score generation unit 242 may further be configured to communicate with memory 206 and/or storage 208 to receive trip related information that may not be included in service request 115. For example, memory 206 and/or storage 208 may store a remoteness score look-up table for trip score generation unit 242 to determine a remoteness score based on the received trip destination information from service request 115. In step S704, trip score generation unit 242 may be configured to apply the selected trip score model on the trip data and the passenger score to generate the trip score.

Returning to FIG. 5, in step 510, request processing unit 244 of request processing device 120 may be configured to compare the generated trip score from step S508 with a predetermined trip score threshold. For example, a value of the generated trip score may be between 0 and 1. A small trip score indicates a low trip risk. If the generated trip score is greater than the predetermined trip score threshold (step S510: Yes), in step S512, request processing unit 244 may be further configured to determine whether the passenger or the request scenario matches any key in a whitelist. In some embodiments, the whitelist may include a list of safe passengers and a list of safe scenarios. For example, one safe scenario can be that the trip remoteness score is less than a preset value (e.g., 0.1).

If the passenger or the scenario matches any of the passengers or the scenarios in the whitelist (step S512: Yes), service request 115 will be allowed to route to the transportation service providers in step S516. If none of the passengers or the scenarios in the whitelist matches the passenger or the scenario of service request 115 (step S512: No), service request 115 will be blocked by request processing unit 244 in step S518. In some alternative embodiments, instead of directly blocking service request 115, request processing unit 244 may conditionally allow service request 115 to route to the transportation service providers in step S516. For example, request processing unit 244 may require the passenger provide authentication information (e.g., a social security number or a driver's license number) and/or a payment method (e.g., payment card number) as part of step S516 in order to continue to route the service request to the transportation service providers.

Returning to step S510, if the generated trip score is not greater than the predetermined trip score threshold (step S510: No), request processing unit 244 may be configured to apply a rule-based model on service request 115. In some embodiments, the rule-based model may identify whether service request 115 includes any unsafe passengers and unsafe scenarios. For example, if the value of passenger frequent cancelation tag is true (e.g., the passenger has a frequent cancelation behavior), the rule-based model may identify the passenger as an unsafe passenger and does not allow service request 115 (step S514: No) to continue. Service request 115 therefore may be blocked or required to provide further information to continue the request in step S518. If the rule-based model does not identify any unsafe passengers and unsafe scenarios in service request 115 (step S514: Yes), request processing unit 244 may allow the ride-hailing platform to route service request 115 to the transportation service providers in step S516.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A system for processing a transportation service request, comprising:
a communication interface configured to receive the transportation service request from a terminal device; and
at least one processor, configured to:
generate a passenger score based on the received transportation service request using a first machine learning model trained with sample passenger data associated with past impacted drivers;
generate a trip score based on the generated passenger score and the received transportation service request using a second machine learning model trained with sample trip data associated with the past impacted drivers; and
allow or block the received transportation service request based on the generated trip score.

2. The system of claim 1, wherein the transportation service request comprises passenger information and trip information.

3. The system of claim 1, wherein to generate a passenger score, the processor is further configured to:
select the first machine learning model based on a quantity of trips completed by the passenger in a predetermined time window; and
generate the passenger score using the selected first machine learning model.

4. The system of claim 3, wherein the first machine learning model is selected from a new passenger model trained with passenger data associated with passengers who have not completed any trip, an infrequent passenger model trained with passenger data associated with passengers who have completed no more than a threshold number of trips, and a frequent passenger model trained with passenger data associated with passengers who have completed more than the threshold number of trips.

5. The system of claim 1, wherein to generate a trip score, the processor is further configured to:
select the second machine learning model based on the selected first machine learning model; and
generate the trip score using the selected second machine learning model.

6. The system of claim 1, wherein the first machine learning model and the second machine learning model are tree-based machine learning models.

7. The system of claim 6, wherein the tree-based machine learning models are selected from random forests, XGBoost, or LightGBM.

8. The system of claim 1, wherein the first machine learning model extracts at least one of the following features: passenger demographics information, passenger's cancelation rate, passenger's destination changing rate, passenger's travel pattern, or passenger's relationship graph; and the second machine learning model uses a remoteness score for the trip destination.

9. The system of claim 1, wherein the at least one processor is further configured to:
determine that the trip score is above a score threshold;
compare the transportation service request with a whitelist comprising a list of safe passengers and a list of safe scenarios; and
allow or block the transportation service request according to the comparison.

10. The system of claim 1, wherein the at least one processor is further configured to:
determine that the trip score is below a score threshold;
check the transportation service request against a rule-based model configured to identify unsafe passengers and unsafe scenarios; and
allow or block the transportation service request according to whether the transportation service request passes the rule-based model.

11. The system of claim 1, wherein the sample passenger data associated with past impacted drivers used to train the first machine learning model is obtained by applying positive weight scale and a norm regularization on imbalanced sample data.

12. A method for processing a transportation service request, comprising:
receiving the transportation service request, by a communication interface, from a terminal device;
generating, by at least one processor, a passenger score based on the received transportation service request using a first machine learning model trained with sample passenger data associated with past impacted drivers;
generating, by the at least one processor, a trip score based on the generated passenger score and the received transportation service request using a second machine learning model trained with sample trip data associated with the past impacted drivers; and
allowing or blocking the received transportation service request, by the at least one processor, based on the generated trip score.

13. The method of claim 12, the transportation service request comprises passenger information and trip information.

14. The method of claim 12, wherein generating a passenger score further comprises:
selecting the first machine learning model, by the at least one processor, based on a quantity of trips completed by the passenger in a predetermined time window; and
generating the passenger score, by the at least one processor, using the selected first machine learning model.

15. The method of claim 14, wherein the first machine learning model is selected from a new passenger model trained with passenger data associated with passengers who have not completed any trip, an infrequent passenger model trained with passenger data associated with passengers who have completed no more than a threshold number of trips, and a frequent passenger model trained with passenger data associated with passengers who have completed more than the threshold number of trips.

16. The method of claim 12, wherein generating a trip score further comprises:
selecting the second machine learning model, by the at least one processor, based on the selected first machine learning model; and
generating the trip score, by the at least one processor, using the selected second machine learning model.

17. The method of claim 12, wherein the first machine learning model and the second machine learning model are tree-based machine learning models selected from random forests, XGBoost, or LightGBM, wherein the first machine learning model extracts at least one of the following features: passenger demographics information, passenger's cancelation rate, passenger's destination changing rate, passenger's travel pattern, or passenger's relationship graph; and the second machine learning model uses a remoteness score for the trip destination.

18. The method of claim 12, further comprising:
determining, by the at least one processor, that the trip score is above a score threshold;
comparing, by the at least one processor, the transportation service request with a whitelist comprising a list of safe passengers and a list of safe scenarios; and
allowing or blocking, by the at least one processor, the transportation service request according to the comparison.

19. The method of claim 12, further comprising:
determining, by the at least one processor, that the trip score is below a score threshold;
checking, by the at least one processor, the transportation service request against a rule-based model configured to identify unsafe passengers and unsafe scenarios; and
allowing or blocking, by the at least one processor, the transportation service request according to whether the transportation service request passes the rule-based model.

20. A non-transitory computer-readable medium having a computer program stored thereon, wherein the computer program, when executed by at least one processor, performs a method for processing a transportation service request, the method comprising:
receiving the transportation service request from a terminal device;
generating a passenger score based on the received transportation service request using a first machine learning model trained with sample passenger data associated with past impacted drivers;
generating a trip score based on the generated passenger score and the received transportation service request using a second machine learning model trained with sample trip data associated with the past impacted drivers; and
allowing or blocking the received transportation service request based on the generated trip score.
